(19) United States
(12) Patent Application Publication
(10) Pub. No.: US 2024/0059322 A1
(43) Pub. Date: Feb. 22, 2024

(54) COOPERATIVE TELEOPERATION

(71) Applicant: FACTION TECHNOLOGY, INC., South San Francisco, CA (US)

(72) Inventors: Ain McKENDRICK, Redwood City, CA (US); Andrea MARIOTTI, Pacifica, CA (US); Mike LOWE, Santa Cruz, CA (US); Peter SCHMIDT, Fredericksburg, TX (US); Pranav BAJORIA, Mountain View, CA (US); Clay POTTORFF, Mountain View, CA (US)

(21) Appl. No.: 18/452,451

(22) Filed: Aug. 18, 2023

Related U.S. Application Data
(60) Provisional application No. 63/371,757, filed on Aug. 18, 2022.

(51) Int. Cl. B60W 60/00; G05D 1/00; G05D 1/02

(52) U.S. Cl. CPC B60W 60/0015; G05D 1/0022; G05D 1/0212; B60W 2556/45

(57) ABSTRACT

An example method to control an autonomous vehicle includes receiving a first signal and receiving a second signal. The first signal includes a first set of parameters that define a planned trajectory for the autonomous vehicle. The second signal includes a second set of parameters that define a planned trajectory for the autonomous vehicle. The method also includes generating a third signal by modifying the first set of parameters of the first signal to include the second set of parameters of the second signal. The method also includes outputting the third signal.

### CROSS-REFERENCE TO RELATED APPLICATION

This application claims the benefit of and priority to U.S. Provisional App. No. 63/371,757 filed on Aug. 18, 2022. The 63/371,757 application is incorporated herein by reference.

### FIELD

The present disclosure is generally related to cooperative teleoperation, specifically related to cooperative teleoperation of autonomous vehicles.

### BACKGROUND

Unless otherwise indicated herein, the materials described herein are not prior art to the claims in the present application and are not admitted to be prior art by inclusion in this section.

Autonomous vehicles are designed to be operated without input from a human operator. However, there may be instances in which an autonomous vehicle may include inadequacies in navigating or responding to its surroundings.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

In an embodiment, a method to control an autonomous vehicle includes receiving a first signal and receiving a second signal. The first signal includes a first set of parameters that define a planned trajectory for the autonomous vehicle. The second signal includes a second set of parameters that define a planned trajectory for the autonomous vehicle. The method also includes generating a third signal by modifying the first set of parameters of the first signal to include the second set of parameters of the second signal. The method also includes outputting the third signal.

In another embodiment, a method to control an autonomous vehicle includes receiving autonomous input for an autonomous vehicle. The autonomous input includes one or both of a planned trajectory or a planned behavior. The method includes receiving teleoperator input that includes one or both of a trajectory adjustment or a behavior authorization. The method includes outputting a trajectory signal that depends on both the autonomous input and the teleoperator input. The trajectory signal includes one or both of an updated planned trajectory or an authorized planned behavior.

In another embodiment, a non-transitory computer-readable storage medium includes computer-readable instructions executable by a processor to perform or control performance of operations. The operations include receiving autonomous input for an autonomous vehicle. The autonomous input includes one or both of a planned trajectory or a planned behavior. The operations include receiving teleoperator input that includes one or both of a trajectory adjustment or a behavior authorization. The operations include outputting a trajectory signal that depends on both the autonomous input and the teleoperator input. The trajectory signal includes one or both of an updated planned trajectory or an authorized planned behavior.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF DESCRIPTION OF THE DRAWINGS

Example embodiments will be described and explained with additional specificity and detail through the use of the accompanying drawings in which:

FIG. 1A illustrates a traditional teleoperation system in a first state;

FIG. 1B illustrates the traditional teleoperation system of FIG. 1A in a second state;

FIG. 2 illustrates an example cooperative teleoperation system;

FIG. 3 illustrates an example operating environment for a cooperative teleoperation system;

FIG. 4 illustrates an example computing system.

FIG. 5 is a flowchart of an example method to control and autonomous vehicle; and

FIG. 6 is a flowchart of another example method to control and autonomous vehicle.

### DESCRIPTION OF EMBODIMENTS

Vehicles may be used for a variety of purposes, including the transportation of persons and/or cargo. Recent developments in technology have begun to enable driverless vehicles, such as autonomous vehicles. Autonomous vehicles are designed to operate independent of human input. For example, an autonomous vehicle may be capable of accelerating, braking, turning, obeying traffic laws, etc., all without input from a teleoperator. In the present disclosure, a teleoperator refers to a remote operator of an autonomous vehicle who is able to (remotely) provide operational input to the autonomous vehicle using remote controls.

For autonomous systems to have control over an autonomous vehicle, electromechanical systems, such as drive by wire, may be implemented in the autonomous vehicle. The electromechanical systems may be systems that use electrical signals in lieu of systems that have previously been mechanical systems. For example, in a drive by wire system, a steering wheel may be replaced such that electrical signals may dictate the control of the steering system and may be termed steer by wire. Alternatively, and/or additionally, a gas pedal may be replaced by electric throttle controls and may be termed throttle by wire. Alternatively, and/or additionally, a brake pedal may be replaced by electronic braking controls and may be termed brake by wire. The various electromechanical systems including steer by wire, throttle by wire, and brake by wire, may be summarized by the term drive by wire, wherein an autonomous vehicle using drive by wire may implement some or all of the underlying electromechanical systems.

Autonomous vehicles may use artificial intelligence (AI) technology as part of an autonomy system to determine and implement a driving strategy in relation to the autonomous vehicle. A driving strategy may include maintaining safe distances from other vehicles and objects, following posted speed limits, maintaining a position in a lane, safely changing lanes when needed, etc. For example, the autonomy system may determine that a speed limit sign indicates a slower maximum speed and the autonomy system may direct the autonomous vehicle to slow down by reducing the amount of applied throttle and/or by braking.

In some circumstances, AI technology may be trained to make decisions regarding the autonomous vehicle's operation through machine learning. Machine learning may include analyzing various scenarios that an autonomous vehicle may encounter while driving. In some circumstances, AI technology may be trained using thousands or millions of scenarios in an attempt to learn appropriate responses to a given situation. For example, AI technology in an autonomy system may learn to rapidly apply the brakes of an autonomous vehicle when brake lights are detected on a vehicle directly in front of the autonomous vehicle.

One common problem with autonomous vehicles and with autonomy systems' control thereof, is the difficulty of including every possible permutation of scenario that may be encountered while driving. As such, there may be instances in which the autonomy system may be unable to determine a course of action. In some circumstances, when confronted with a new or unexpected scenario, an autonomy system may determine to pull over and stop, or more drastically, to immediately stop in the lane. Immediately stopping in lane, or even pulling over and stopping, may introduce additional hazards to the autonomous vehicle and the passengers and/or cargo therein. For example, immediately stopping may increase the chances of being rear-ended by another automobile following the autonomous vehicle. As another example, pulling over and stopping may occur in a hazardous location, such as a narrow shoulder on an interstate, or a shoulder that contains debris prone to puncturing tires.

A common solution to bridge the gap between pure autonomous vehicles using an autonomy system (where “pure” autonomy may indicate a fully operational autonomous vehicle in all circumstances, without any human input) and the problems associated with unpredictable driving scenarios is to implement teleoperation functionality in the autonomous vehicle system. Teleoperation functionality allows a teleoperator to provide input to the autonomous vehicle. Navigation scenarios that might be difficult to handle autonomously may be a relatively simple procedure for a teleoperator to maneuver.

In some circumstances, teleoperations between a teleoperator and an autonomous vehicle may be configured to be transmitted over a network. The network may include the Internet, one or more cellular radio frequency (RF) networks, and/or one or more wired and/or wireless networks.

In some circumstances, teleoperations may introduce human oversight and/or control into the autonomous vehicle system which may aid in circumventing potential issues in which an autonomy system may not be equipped to handle. In some circumstances, teleoperations may provide a video feed from the autonomous vehicle which may enable remote operation of an autonomous vehicle. For example, a teleoperator may be able to assume direct control of an autonomous vehicle even if located remotely.

A first mode of teleoperations may be direct teleoperation. Under direct teleoperation, a teleoperator may remotely provide all the controls to an autonomous vehicle. For example, a teleoperator may provide remote inputs that control the steering, acceleration, and braking of an autonomous vehicle. In some circumstances, direct teleoperation may be a fast method of teleoperations to deploy as teleoperators are generally experienced at handling unexpected scenarios while driving. Alternatively, and/or additionally, some maneuvers and/or scenarios an autonomous vehicle may encounter may be exceptionally difficult to resolve using an autonomy system, but those maneuvers and/or scenarios may be easily handled by a teleoperator controlling the autonomous vehicle under direct teleoperation.

However, direct teleoperation may require the teleoperator to have a high level of training and/or proficiency in remote vehicle operations. For example, fully controlling an autonomous vehicle via remote control using video feeds and drive by wire technology may be substantially different than operating an automobile in the driver's seat and may require substantial training to become proficient. Alternatively, and/or additionally, the teleoperator may encounter delays in the video feed and controls due to latency in the network, which may be mitigated by additional training and/or limiting direct teleoperations of the autonomous vehicle to low speed environments. Alternatively, and/or additionally, direct teleoperations may introduce a heavy cognitive strain on a teleoperator as the teleoperator must maintain a heightened focus on the task of remote operation.

A second mode of teleoperations may be supervised teleoperation. Supervised teleoperation may permit a teleoperator to handle high-level decisions related to operating an autonomous vehicle, while an autonomy system may govern more simple, predefined operations. For example, an autonomous vehicle travelling on a highway under supervised teleoperation may use the autonomy system to maintain its position in lane, but the autonomy system may not change lanes unless directed by a teleoperator. Supervised teleoperation may include a smaller teleoperator workload compared to direct teleoperation as teleoperator input is only required in decision making, as opposed to complete control of the autonomous vehicle under direct teleoperation. Alternatively, and/or additionally, the autonomy system of the autonomous vehicle under supervised teleoperation may continue to implement collision avoidance as a safety measure for the teleoperators' decisions.

In some circumstances, the predefined operations under supervised teleoperation may be limited to relatively simple maneuvers by an autonomous vehicle. For example, predefined operations may include throttle control, brake control, steering controls to maintain lane-keeping, distance between other vehicles, etc. Alternatively, and/or additionally, supervised teleoperation may be an inadequate method of control over an autonomous vehicle when the environment becomes more dynamic or difficult to maneuver. In instances in which the environment becomes too complex for supervised teleoperation, the autonomous vehicle may revert to direct teleoperation, as discussed above. For example, supervised teleoperation may be unsuitable for an autonomous vehicle entering a city environment or a parking lot and the autonomous vehicle may transition to direct teleoperations, requiring a teleoperator to remotely control the autonomous vehicle.

In some circumstances, direct teleoperation and supervised teleoperation may be modal in application. For example, in instances in which direct teleoperation are implemented, supervised teleoperation may be inoperative. Additionally, in instances in which an autonomous vehicle is operating under supervised teleoperations, direct teleoperation may be disabled.

A third mode of teleoperations may be cooperative teleoperation. In some embodiments, cooperative teleoperation may employ an autonomy system to maneuver an autonomous vehicle while accepting input from a teleoperator as part of the planning and control of the movement of the autonomous vehicle. For example, an autonomous vehicle's autonomy system may determine a first path to navigate a portion of roadway. With the autonomy system still functioning, a teleoperator may make an “on the fly” adjustment to the movement and trajectory of the autonomous vehicle. In some embodiments, the autonomy system may update the determined path in response to the input from the teleoperator.

In some embodiments, cooperative teleoperation may enable the autonomy system to continually operate while the autonomous vehicle is in motion. For example, the autonomy system may not disengage when a teleoperator provides input or control over the autonomous vehicle. In some embodiments, the autonomy system of an autonomous vehicle in cooperative teleoperations may automatically recalculate the autonomous vehicle's trajectory in response to receiving input from a teleoperator. Alternatively, and/or additionally, the autonomy system may receive and implement additional input from the teleoperator and further refine the planned trajectory of the autonomous vehicle.

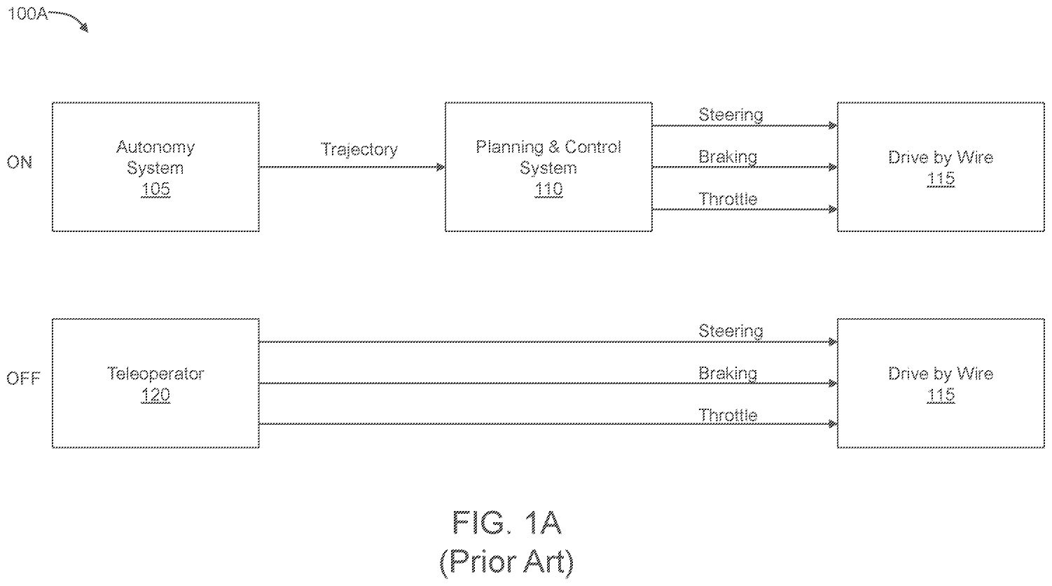

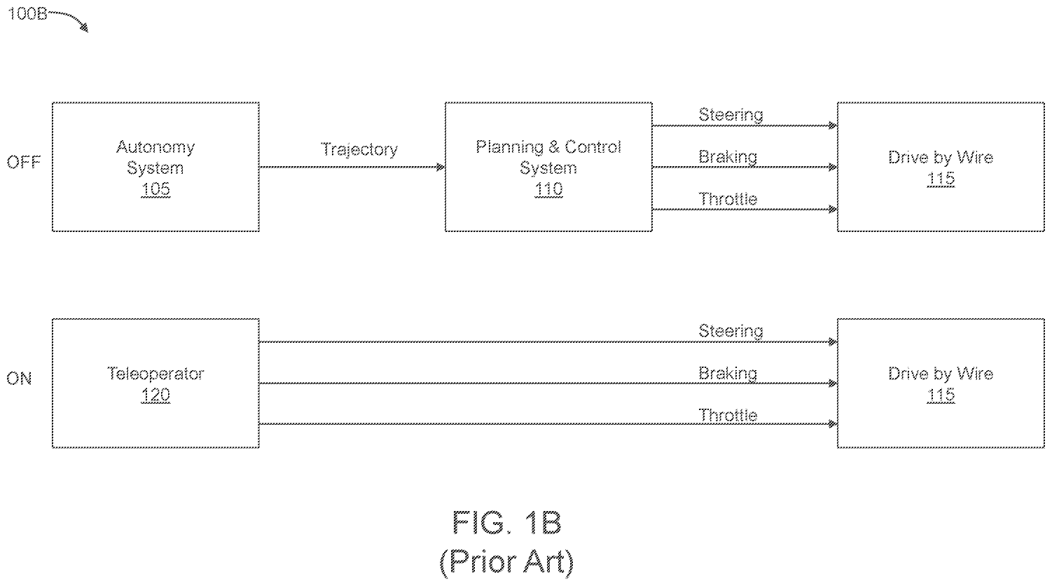

FIG. 1A illustrates a traditional teleoperation system in a first state 100A. FIG. 1B illustrates the traditional teleoperation system of FIG. 1B in a second state 100B. The teleoperation system of FIGS. 1A and 1B is generically referred to herein as the teleoperation system 100. FIGS. 1A and 1B generally illustrate the modality of direct teleoperations in operation. As illustrated in FIGS. 1A and 1B, the teleoperation system 100 may include an autonomy system 105, a planning and control system 110, a drive by wire system 115, and a teleoperator 120.

In some embodiments, the teleoperation system 100 may include a planning and control system 110 coupled between the autonomy system 105 and the drive by wire system 115. In some embodiments, an output of the autonomy system 105 may include a planned trajectory. The planned trajectory may include an initial route for an autonomous vehicle to traverse without additional input from another system or a human operator or teleoperator. In some embodiments, the planned trajectory may be input to the planning and control system 110, which may be used to determine the method of implementation for the planned trajectory. For example, the planning and control system 110 may be configured to determine an operation speed, accelerations or decelerations, a drive line, and/or other trajectory variables that may be associated with the trajectory from the autonomy system 105.

In some embodiments, the planning and control system 110 may output multiple signals associated with the received trajectory. For example, the planning and control system 110 may be configured to output at least a steering signal, a braking signal, and a throttle signal. The multiple signals from the planning and control system 110 may be input into the drive by wire system 115, which may be used to control and/or operate the autonomous vehicle. Although not illustrated in FIGS. 1A and 1B, one or more of the autonomy system 105, planning and control system 110, and/or drive by wire system 115 may be implemented in the autonomous vehicle.

In some embodiments, the teleoperator 120 may be configured to provide input to the teleoperation system 100. For example, the teleoperator 120 may provide an input that may be directly routed into the drive by wire system 115, such that the teleoperator 120 has remote, direct control over the autonomous vehicle.

FIG. 1A illustrates a first mode of the teleoperation system 100A, where the autonomy system 105 of the autonomous vehicle may be enabled and the teleoperator 120 may be disabled. In some embodiments, the first teleoperation system 100A may be configured to autonomously determine a trajectory for an autonomous vehicle. For example, the autonomy system 105 may determine the trajectory and transmit the trajectory to the planning and control system 110. The planning and control system 110 may determine various components to implementation of the trajectory, such as a steering component, a throttle component, a brake component, etc. and may transmit the trajectory components to the drive by wire system 115. The drive by wire system 115 may apply the trajectory components such that the associated autonomous vehicle may follow the trajectory as determined by the autonomy system 105.

FIG. 1B illustrates a second mode of the teleoperation system 100B, where the autonomy system 105 of the autonomous vehicle may be disabled and the teleoperator 120 may be enabled. In some embodiments, the second teleoperation system 100B may be configured to receive teleoperator 120 input in control of the autonomous vehicle, such as in instances where navigation exceeds a complexity threshold. In the second teleoperation system 100B, the teleoperator 120 may provide the steering, braking, throttle, and/or other trajectory components to the drive by wire system 115, which may be used to implement a trajectory for the autonomous vehicle while under the control of the teleoperator 120.

In these and other embodiments, operation of the first teleoperation system 100A (e.g., the autonomy system 105 enabled and the teleoperator 120 disabled) may be mutually exclusive to operation of the second teleoperation system 100B (e.g., the autonomy system 105 disabled and the teleoperator 120 enabled). For example, both the autonomy system 105 and the teleoperator 120 may be connected to the drive by wire system 115 such that if both the autonomy system 105 and the teleoperator 120 are enabled, competing instructions may be issued to the drive by wire system 115 which may cause an increase in the likelihood of an incorrect trajectory which may lead to an accident or other undesirable scenario. To avoid such a scenario, the two states 100A, 100B of the teleoperation system 100 may be mutually exclusive.

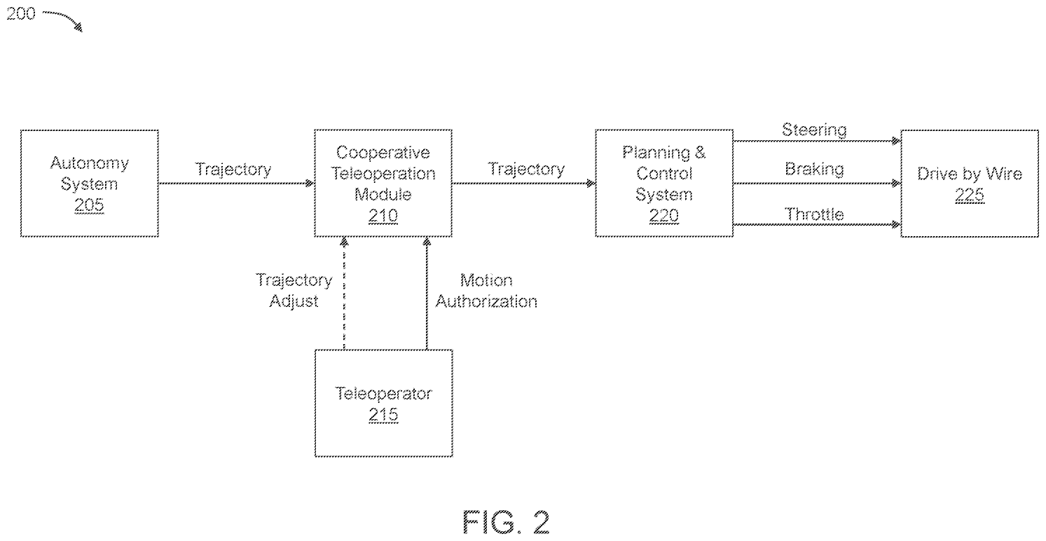

FIG. 2 illustrates an example cooperative teleoperation system 200, in accordance with at least one embodiment described in the present disclosure. The cooperative teleoperation system 200 may include an autonomy system 205, a cooperative teleoperation module (CTM) 210, a teleoperator 215, a planning and control system 220, and a drive by wire system 225. In some embodiments, the autonomy system 205, the planning and control system 220, the drive by wire system 225, and the teleoperator 215 may be similar or analogous to, respectively, the autonomy system 105, the planning and control system 110, the drive by wire system 115, and the teleoperator 120 of FIGS. 1A and 1B.

In some embodiments, the CTM 210 may be disposed between the autonomy system 205 and the planning and control system 220. In some embodiments, the trajectory output of the autonomy system 205 may be an input into the CTM 210. Alternatively or additionally, an output of the CTM 210 may include a trajectory that may be an input into the planning and control system 220. In some embodiments, the CTM 210 may introduce no changes to the trajectory, such that the trajectory output from the autonomy system 205 may be similar or identical to the trajectory input into the planning and control system 220. Alternatively or additionally, the trajectory may be varied or modified by the CTM 210.

In some embodiments, the CTM 210 may be configured to receive the trajectory from the autonomy system 205. Alternatively or additionally, the CTM 210 may be configured to receive input from the teleoperator 215. For example, input from the teleoperator 215 may include trajectory adjustments, motion authorization, and/or other controls or instructions from the teleoperator 215.

In some embodiments, the autonomy system 205 may provide a visual indication to the teleoperator 215 of the planned trajectory for the teleoperator 215 to review and/or authorize implementation. For example, the autonomy system 205 may provide a current visualization of the current navigation setting and may overlay the planned trajectory onto the visualization. In some embodiments, an output from the teleoperator 215 may include a trajectory adjustment to the planned trajectory output from the autonomy system 205. For example, an autonomy system 205 may determine a first trajectory and a teleoperator 215 may determine that a second trajectory is a better route for an autonomous vehicle. The teleoperator 215 may adjust the first trajectory to match the second trajectory to create the planned trajectory for the autonomous vehicle. Alternatively, and/or additionally, an output from the teleoperator 215 may include motion authorization. For example, the planned trajectory may be ready to be implemented and the teleoperator 215 may provide an indication to the system that the autonomous vehicle may proceed with the trajectory.

In these and other embodiments, the motion authorization provided by the teleoperator 215 may be partial or complete with respect to the planned trajectory from the autonomy system 205. For example, in a complex navigation setting, the cooperative teleoperation system 200 may request motion authorization for all planned trajectories of an autonomous vehicle. In another example, an autonomous vehicle in a simpler navigable scenario may request motion control only when encountering more complex trajectories. Alternatively, and/or additionally, the cooperative teleoperation may not request any motion authorization and may operate independent of additional input from the teleoperator 215.

In these and other embodiments, the CTM 210 may be configured to receive inputs from both the autonomy system 205 and the teleoperator 215 and may use the inputs to determine the trajectory that may be transmitted to the planning and control system 220. For example, based on the initial trajectory from the autonomy system 205, the CTM 210 may adjust the trajectory based on input from the teleoperator 215, and may transmit the adjusted trajectory to the planning and control system 220.

In some embodiments, one or more of the autonomy system 205, the CTM 210, and/or the planning and control system 220 may remain in charge of the safety of the autonomous vehicle even when receiving or implementing input from the teleoperator 215. For example, while the planning and control system 220 is implementing a trajectory from the CTM 210 that is based on an initial trajectory from the autonomy system as authorized or modified by the teleoperator 215, the planning and control system 220 may determine whether and when it is safe to move and how to move and may output trajectory signals to the drive by wire system 225 that are consistent with its determinations.

As in the teleoperation system 100 of FIGS. 1A and 1B, the cooperative teleoperation system 200 of FIG. 2 may implement one or more predefined operations or behaviors in the autonomous vehicle. The predefined operations or behaviors may include maintaining lane position, overtaking (e.g., other vehicles) on the left, collision avoidance, merging, or the like. In some embodiments, some portions or all of a given predefined operation or behavior may require authorization by the teleoperator 215. Alternatively or additionally, the cooperative teleoperation system 200 of FIG. 2 may implement one or more on the fly operations or behaviors in the autonomous vehicle. On the fly operations or behaviors may include execution or implementation of trajectories input by the teleoperator 215.

In some embodiments, the predefined operations or behaviors may be compiled into a library or catalog on or accessible to one or more of the autonomy system 205, the CTM 210, the planning and control system 220, or other component(s) of the cooperative teleoperation system 200. The predefined operations or behaviors may, in some embodiments, be automatically triggered or executed based on contextual information such as location, lane, hotspot type, time of day, season, weather conditions, agent (e.g., a specific teleoperator 215) involved, or other contextual information available to the cooperative teleoperation system 200. Alternatively or additionally, the predefined operations or behaviors in the library or catalog may initially require authorization from the teleoperator 215. Over time, the teleoperator 215 may repeatedly authorize one or more of the predefined operations or behaviors under conditions that are tracked, e.g., as contextual information. With enough contextual information accumulated over time for enough authorizations of a given predefined operations or behaviors, the CTM 210 or other component(s) of the cooperative teleoperation system may learn when the predefined operation or behavior may be automatically executed without requiring express authorization from the teleoperator 215.

Various degrees of functionality of cooperative teleoperation will now be described in three embodiments illustrating different modes of operation. In a first mode, the autonomy system 205 of the cooperative teleoperation system 200 of an autonomous vehicle may generate a trajectory, may transmit the trajectory to the planning and control system 220 (e.g., through the CTM 210) which may implement control systems to achieve the trajectory, and may execute the planned trajectory using the drive by wire system 225. In some embodiments of the first mode, the autonomy system 205 may generate the trajectory, implement the trajectory, and execute the trajectory without any input from an outside source including the teleoperator 215. The autonomous vehicle may be capable of making the determinations based on learned scenarios, precise sensors, and/or an uncomplicated navigation environment. For example, an autonomous vehicle may be capable of navigating a roadway which has previously been traversed, and which may be substantially devoid of pedestrians and/or other less predictable objects.

In a second mode, the autonomy system 205 of the autonomous vehicle may interpret the surroundings and generate a suitable trajectory in response to the determined surroundings. Unlike the first mode, authorization to move may be under the direction of the teleoperator 215. In some embodiments, the teleoperator 215 may have control over the autonomous vehicle's movement using a control knob, a control lever, or other input device. In these and other embodiments, the teleoperator 215 may be able to throttle the degree of movement of an autonomous vehicle, in the autonomous vehicle's attempt to follow the determined trajectory. In some embodiments, the control exhibited by the teleoperator 215 over the autonomous vehicle may range from free autonomy to completely stopped. In these and other embodiments, the teleoperator 215 may determine the current navigation environment is too complex and may revert the entire system into direct teleoperation until the navigation setting may be less complex.

In a third mode, the autonomy system 205 may determine a trajectory, similar to the prior two modes. However, the teleoperator 215 may intervene in the trajectory using at least a control knob (similar to the control knob described with respect to the second mode) and a steering mechanism and/or other input device(s). In some embodiments, the autonomy system 205 may determine a trajectory that the teleoperator 215 desires to overrule or otherwise modify. In these and other embodiments, the teleoperator 215 may provide a modified trajectory using at least the steering mechanism. In some embodiments, the teleoperator 215 may provide movement authorization to the autonomous vehicle after the teleoperator 215 has modified the trajectory. Alternatively, and/or additionally, the teleoperator 215 may provide movement authorization to the autonomous vehicle prior to the teleoperator 215 modifying the trajectory. In these and other embodiments, the autonomy system 205 may continue to generate a trajectory for the autonomous vehicle after receiving the modified trajectory from the teleoperator 215.

In these and other embodiments, the trajectory from the autonomy system 205 may be combined with and/or altered by the trajectory or other input from the teleoperator 215 in the CTM 210. The CTM 210 may output the final trajectory to the planning and control system 220 which trajectory may include the trajectory from the autonomy system 205 and any alterations to the trajectory from the teleoperator 215.

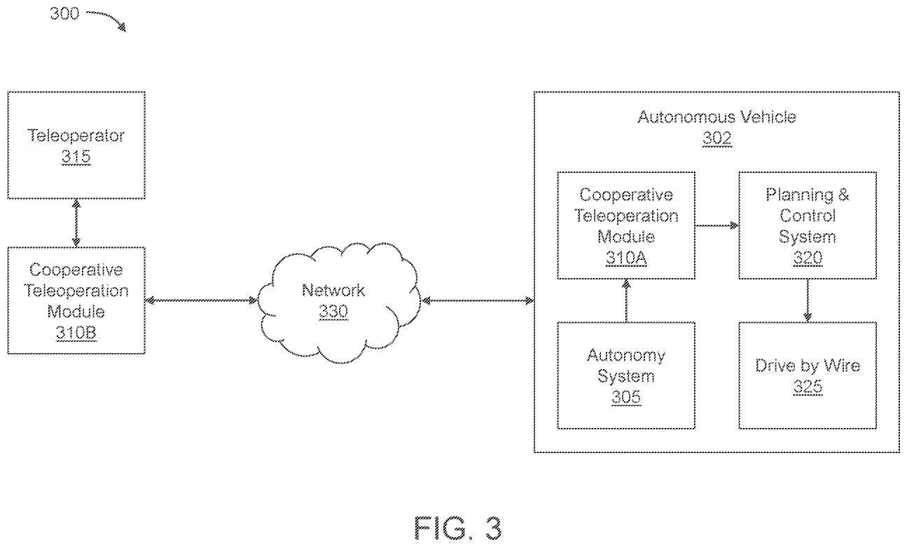

FIG. 3 illustrates an example operating environment 300 for a cooperative teleoperation system, in accordance with at least one embodiment of the present disclosure. The environment 300 may include an autonomous vehicle 302, a teleoperator 315, and a network 330. The autonomous vehicle 302 may include an autonomy system 305, a CTM 310, a planning and control system 320, and a drive by wire system 325. The CTM 310 may include a first component 310A (hereinafter “CTM 310A”) and a second component 310B (hereinafter “CTM 310B”) described in more detail elsewhere herein.

The CTM 310A may be implemented on the autonomous vehicle 302 while the CTM 310B may be implemented in the cloud, e.g., on a server, or otherwise remotely from the autonomous vehicle 302. The CTMs 310A, 310B may “talk” to each other, e.g., exchange communications. The functionality of the CTM 310 described herein may be distributed evenly or unevenly between the CTMs 310A, 310B.

In some embodiments, the autonomy system 305, the CTM 310, the teleoperator 315, the planning and control system 320, and the drive by wire system 325 may collectively form a cooperative teleoperation system which may be the same as, similar to, and/or identical to the cooperative teleoperation system 200 of FIG. 2. Alternatively or additionally, the autonomy system 305, the CTM 310, the teleoperator 315, the planning and control system 320, and the drive by wire system 325 may be analogous, similar, or identical to, respectively, the autonomy system 205, the CTM 210, the teleoperator 215, the planning and control system 220, and the drive by wire system 225 of FIG. 2.

In some embodiments, the network 330 may be configured to communicatively couple the teleoperator 315 and the autonomous vehicle 302, e.g., via the CTM 310. In some embodiments, the network 330 may be any network or configuration of networks configured to send and receive communications between systems. In some embodiments, the network 330 may include the Internet, including a global internetwork formed by logical and physical connections between multiple WANs and/or LANs. Alternately or additionally, the network 330 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 330 may also include servers that enable one type of network to interface with another type of network.

In some embodiments, the cooperative teleoperation system of FIG. 3 (i.e., the cooperative teleoperation system collectively formed by the autonomy system 305, the CTM 310, the teleoperator 315, the planning and control system 320, and the drive by wire system 325) may be configured to operate similar or identical to the cooperative teleoperation system 200. For example, the autonomous vehicle 302 may be controlled by a combination of the autonomy system 305, the CTM 310, the teleoperator 315, the planning and control system 320, and/or the drive by wire system 325. In some embodiments, the cooperative teleoperation system of FIG. 3 may provide operation of the autonomous vehicle 302 where one or more of the components of the cooperative teleoperation system may be remote from the autonomous vehicle 302. For example, as illustrated, the teleoperator 315 and the CTM 310B may be remote from the autonomous vehicle 302 which may include the autonomy system 305, the CTM 310B, the planning and control system 320, and the drive by wire system 325. Alternatively or additionally, one or more of the components associated with the autonomous vehicle 302 in FIG. 3 may be located in a system associated with the teleoperator 315, the network 330, and/or any other remote system.

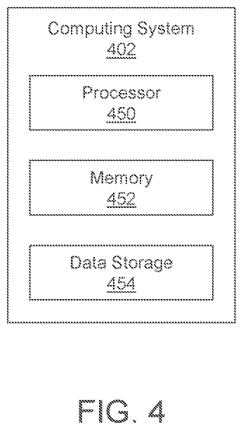

In some embodiments, some or all the operations performed by the teleoperator 315, the CTM 310B, and/or the components of the autonomous vehicle 302 (e.g., the autonomy system 305, the CTM 310A, the planning and control system 320, and the drive by wire system 325) may be performed by a computing system, such as the computing system 402 of FIG. 4.

Although not illustrated in FIG. 3, the autonomous vehicle 302 may include one or more sensors and/or other hardware and/or software to detect and/or remotely monitor an environment and/or context of the autonomous vehicle 302. For example, the autonomous vehicle 302 may include one or more video cameras, a communication device, an accelerometer, a gyroscope, a global positioning system (GPS) device, a radar device, a LIDAR device, a thermal infrared device, an ultrasonic device, and/or other sensors. The one or more sensors, hardware, and/or software may, in some embodiments, be arranged and/or operated as described in U.S. patent application Ser. No. 18/316,119, filed May 11, 2023, and entitled DYNAMIC 360-DEGREE VIRTUAL SENSOR MAPPING, and which is incorporated herein by reference in its entirety. Some or all of the data (e.g., video feeds) generated at the autonomous vehicle 302 may be provided to the teleoperator 315, e.g., as described in the '119 application for monitoring and/or teleoperation. Providing such data to the teleoperator 315 may provide the teleoperator 315 with sufficient context, or situational awareness, to intervene in the operation of and/or assist the autonomous vehicle 302, e.g., to alter a planned trajectory, authorize a planned behavior, or the like.

Monitoring the autonomous vehicle 302 (e.g., as facilitated by the one or more sensors, hardware, and/or software) may include or involve an ability to see telemetry such as speed, turn indicators, parking brakes, gear states, and location information; an ability to get contextual information of the autonomous vehicle 302 such as camera streams from some or all angles and/or thermal camera images or streams; an ability to visualize a planned trajectory and/or a planned behavior of the autonomous vehicle 302; and/or an ability to flag events and create recordings that can be analyzed later for continuous improvement of the technology stack.

In these and other embodiments, the input provided by the teleoperator 315 to the autonomous vehicle 302 (and specifically, to the CTM 310) may include course correction of vehicle pathing, behavior authorization, readying the autonomous vehicle 302 for deployment on a mission, selecting a maximum authorized speed for the autonomous vehicle 302, resuming full autonomous operation on a mission after receiving input from the teleoperator 315, control of a parking brake and/or hazard lights of the autonomous vehicle, and/or other input. In some embodiments, the input provided by the teleoperator 315 to the autonomous vehicle 302 excludes vehicle finer control such as steering, braking, throttle control, or the like due to safety concerns around latency and bandwidth.

Although not necessarily illustrated in FIG. 3, in some embodiments the CTM 310 may include one or more of the following in different locations of the cooperative teleoperation system of FIG. 3: a control surface, a user interface (UI), backend cloud infrastructure, and/or an on-vehicle system.

The control surface may include a generic or dedicated hardware controller that links up with the UI and allows the teleoperator 315 to take any relevant actions. The UI may include a web application that runs on any web browser (or other application) with authentication that the teleoperator 315 may use to get context of the vehicle in terms of, e.g., a telemetry feed, real-time camera streams, and vehicle intent. The UI may also be used to give feedback to the teleoperator 315 for status of commands that are issued. The backend infrastructure may include a system that resides in, e.g., the AWS cloud (or more generally, in the network 330) that is responsible for the commands and the telemetry feed & camera streams exchanged between the teleoperator 315 and the autonomous vehicle 302 in a safe and secure way that is scalable for many users and fleets of autonomous vehicles. The on-vehicle system may include a system that relays all the telemetry and camera feed and/or other data from the autonomous vehicle 302 to the backend cloud infrastructure and receives commands from the teleoperator 315 to carry out the commands in conjunction with the planning and control system 320. Other arrangements of the foregoing components and/or of the CTM 310 itself are also contemplated and within the scope of the present disclosure.

FIG. 4 illustrates a block diagram of an example computing system 402, according to at least one embodiment of the present disclosure. The computing system 402 may be configured to implement or direct one or more operations associated with a cooperative teleoperation system (e.g., the cooperative teleoperation system 200 of FIG. 2). In some embodiments, the computing system 402 may be implemented or included in an autonomous vehicle, such as the autonomous vehicle 302 of FIG. 3. The computing system 402 may include a processor 450, a memory 452, and a data storage 454. The processor 450, the memory 452, and the data storage 454 may be communicatively coupled.

In general, the processor 450 may include any suitable special-purpose or general-purpose computer, computing entity, or processing device including various computer hardware or software modules and may be configured to execute instructions stored on any applicable computer-readable storage media. For example, the processor 450 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 450 may include any number of processors configured to, individually or collectively, perform or direct performance of any number of operations described in the present disclosure. Additionally, one or more of the processors may be present on one or more different electronic devices, such as different servers.

In some embodiments, the processor 450 may be configured to interpret and/or execute program instructions and/or process data stored in the memory 452, the data storage 454, or the memory 452 and the data storage 454. In some embodiments, the processor 450 may fetch program instructions from the data storage 454 and load the program instructions in the memory 452. After the program instructions are loaded into memory 452, the processor 450 may execute the program instructions.

For example, in some embodiments, the modification module may be included in the data storage 454 as program instructions. The processor 450 may fetch the program instructions of a corresponding module from the data storage 454 and may load the program instructions of the corresponding module in the memory 452. After the program instructions of the corresponding module are loaded into memory 452, the processor 450 may execute the program instructions such that the computing system may implement the operations associated with the corresponding module as directed by the instructions.

The memory 452 and the data storage 454 may include computer-readable storage media for carrying or having computer-executable instructions or data structures stored thereon. Such computer-readable storage media may include any available media that may be accessed by a general-purpose or special-purpose computer, such as the processor 450. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 450 to perform a certain operation or group of operations.

Modifications, additions, or omissions may be made to the computing system 402 without departing from the scope of the present disclosure. For example, in some embodiments, the computing system 402 may include any number of other components that may not be explicitly illustrated or described.

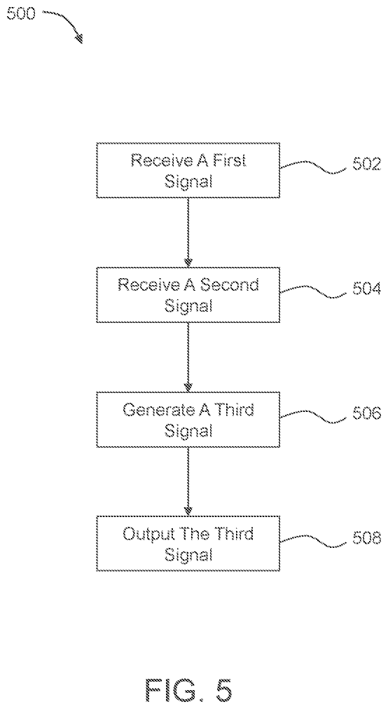

FIG. 5 is a flowchart of an example method 500 to control an autonomous vehicle, arranged in accordance with at least one embodiment described herein. The method 500 may be performed by any of the systems, modules, and/or devices described herein, such as the cooperative teleoperation system 200 of FIG. 2 or of FIG. 3, the CTM 210, 310, or the like. In some embodiments, the method 500 may be embodied in code or other computer-readable instructions stored in a memory or other computer-readable storage media and executable by a processor, such as the processor 450, to cause the processor to perform or control performance of one or more of the functions or operations of the method 500. The method 500 may be performed by processing logic that may include hardware (circuitry, dedicated logic, etc.), software (such as is run on a computer system or a dedicated machine), or a combination of both, which processing logic may be included in, e.g., the processor 450 of FIG. 4 or another device, combination of devices, or systems. The method 500 may include one or more of blocks 502, 504, 506, and/or 508.

At block 502, the method 500 may include receiving a first signal. The first signal may include a first set of parameters that define a planned trajectory for the autonomous vehicle. In some embodiments, receiving the first signal may include the CTM 210 receiving the trajectory from the autonomy system 205. Alternatively or additionally, the first set of parameters may be obtained from a library of predefined parameters. The library of predefined parameters may include predefined deterministic behaviors for the autonomous vehicle in response to a stimulus. The predefined deterministic behaviors may include at least one of throttle control, brake control, steering control to maintain lane-keeping, distance control to maintain distance between the autonomous vehicle and other vehicles, overtaking other vehicles on the left, collision avoidance, or merging. Block 502 may be followed by block 504.

At block 504, the method 500 may include receiving a second signal. The second signal may include a second set of parameters that define a planned trajectory for the autonomous vehicle. In some embodiments, receiving the second signal may include the CTM 210 receiving the trajectory adjustment or motion (or other behavior) authorization from the teleoperator 215. Alternatively or additionally, the second set of parameters may include input from a teleoperator. For example, the input from the teleoperator may include at least one of an alteration or modification to the planned trajectory defined by the first parameters or an authorization of some or all of the planned trajectory. Block 504 may be followed by block 506.

At block 506, the method 500 may include generating a third signal. The third signal may be generated by modifying the first set of parameters of the first signal to include the second set of parameters of the second signal. In some embodiments, generating the third signal may include the CTM 210 generating the third signal based on the trajectory signal from the autonomy system and one or both of the trajectory adjustment or motion (or other behavior) authorization from the teleoperator 215. Block 506 may be followed by block 508.

At block 508, the method 500 may include outputting the third signal. In some embodiments, outputting the third signal at block 508 includes the CTM 210 outputting the updated trajectory and/or authorized behavior to the planning and control system 220.

Modifications, additions, or omissions may be made to the method 500 without departing from the scope of the present disclosure. For example, in some embodiments, the method 500 may include any number of other blocks that may not be explicitly illustrated or described. Alternatively, or additionally, one or more blocks included in the method 500 may be performed sequentially, or in parallel, as applicable.

As a particular example, the method 500 may further include determining trajectory components to implement a trajectory defined by the third signal and executing the trajectory defined by the third signal. Executing the trajectory defined by the third signal may include executing the trajectory components at a drive by wire system of the autonomous vehicle, such as the drive by wire system 225 of FIG. 2. As another example, the method 500 may further include, prior to executing the trajectory defined by the third signal, determining whether it is safe to implement the trajectory defined by the third signal. In this and other embodiments, executing the trajectory defined by the third signal may occur only after determining that it is safe to execute the trajectory defined by the third signal.

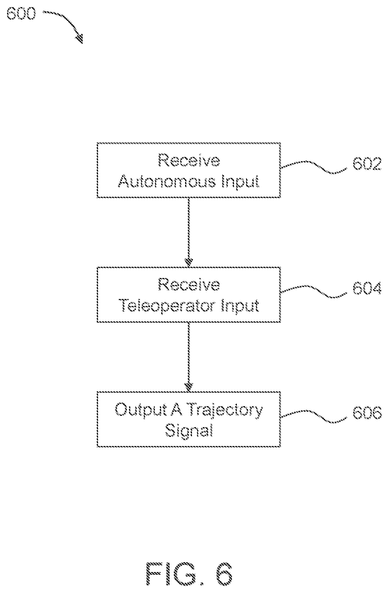

FIG. 6 is a flowchart of another example method 600 to control an autonomous vehicle, arranged in accordance with at least one embodiment described herein. The method 600 may be performed by any of the systems, modules, and/or devices described herein, such as the cooperative teleoperation system 200 of FIG. 2 or of FIG. 3, the CTM 210, 310, or the like. In some embodiments, the method 600 may be embodied in code or other computer-readable instructions stored in a memory or other computer-readable storage media and executable by a processor, such as the processor 450, to cause the processor to perform or control performance of one or more of the functions or operations of the method 600. The method 600 may be performed by processing logic that may include hardware (circuitry, dedicated logic, etc.), software (such as is run on a computer system or a dedicated machine), or a combination of both, which processing logic may be included in, e.g., the processor 450 of FIG. 4 or another device, combination of devices, or systems. The method 600 may include one or more of blocks 602, 604, and/or 606.

At block 602, the method 600 may include receiving autonomous input for an autonomous vehicle. The autonomous input may include one or both of a planned trajectory or a planned behavior. In some embodiments, receiving the autonomous input may include the CTM 210 receiving the trajectory or a planned behavior from the autonomy system 205. Alternatively or additionally, the autonomous input includes the planned behavior and the planned behavior is automatically triggered based on contextual information. The contextual information may include at least one of a geographic location, a lane location, a hotspot type, a time of day, a season, weather conditions, or a current teleoperator for the autonomous vehicle. In some embodiments, the autonomous input includes the planned behavior, the planned behavior is obtained from a library of predefined behaviors, and the predefined behaviors are populated in the library over time based on prior authorizations of the predefined behaviors by a plurality of teleoperators. Alternatively or additionally, the planned behavior may include at least one of throttle control, brake control, steering control to maintain lane-keeping, distance control to maintain distance between the autonomous vehicle and other vehicles, overtaking other vehicles on the left, collision avoidance, or merging. Block 602 may be followed by block 604.

At block 604, the method 600 may include receiving teleoperator input, e.g., from a teleoperator. The teleoperator input may include one or both of a trajectory adjustment or a behavior authorization. In some embodiments, receiving the teleoperator input may include the CTM 210 receiving the trajectory adjustment or motion (or other behavior) authorization from the teleoperator 215. Block 604 may be followed by block 606.

At block 606, the method 600 may include outputting a trajectory signal that depends on both the autonomous input and the teleoperator input. The trajectory signal may include one or both of an updated planned trajectory or an authorized planned behavior. In some embodiments, outputting the trajectory signal at block 606 includes the CTM 210 outputting the updated trajectory and/or authorized behavior to the planning and control system 220.

In some embodiments, the method 600 further includes determining whether it is safe for the autonomous vehicle to implement one or both of the updated planned trajectory or the authorized planned behavior. In an example, the determination may be made planning and control system 220. Alternatively or additionally, the method 600 further includes executing at the autonomous vehicle one or both of the updated planned trajectory or the authorized planned behavior only after determining that it is safe to do so. In an example, the execution is performed by the drive by wire system 225.

In some embodiments, the method 600 further includes determining trajectory components to implement the updated planned trajectory or the authorized planned behavior. The trajectory components may be determined by, e.g., the planning and control system 220. Alternatively or additionally, the method 600 further includes executing the updated planned trajectory or the authorized planned behavior, including executing the trajectory components at a drive by wire system of the autonomous vehicle.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method to control an autonomous vehicle comprising:
receiving a first signal, the first signal comprising a first set of parameters that define a planned trajectory for the autonomous vehicle;
receiving a second signal, the second signal comprising a second set of parameters that define a planned trajectory for the autonomous vehicle;
generating a third signal by modifying the first set of parameters of the first signal to include the second set of parameters of the second signal; and
outputting the third signal.

2. The method of claim 1 wherein, the first set of parameters are obtained from a library of predefined parameters, the library of predefined parameters including predefined deterministic behaviors for the autonomous vehicle in response to a stimulus.

3. The method of claim 2, wherein the predefined deterministic behaviors include at least one of throttle control, brake control, steering control to maintain lane-keeping, distance control to maintain distance between the autonomous vehicle and other vehicles, overtaking other vehicles on the left, collision avoidance, or merging.

4. The method of claim 1, wherein the second set of parameters comprises input from a teleoperator.

5. The method of claim 4, wherein the input from the teleoperator comprises at least one of an alteration or modification to the planned trajectory defined by the first parameters or an authorization of some or all of the planned trajectory.

6. The method of claim 1, further comprising:
determining trajectory components to implement a trajectory defined by the third signal; and
executing the trajectory defined by the third signal, including executing the trajectory components at a drive by wire system of the autonomous vehicle.

7. The method of claim 6, further comprising, prior to executing the trajectory defined by the third signal, determining whether it is safe to implement the trajectory defined by the third signal, wherein executing the trajectory defined by the third signal occurs only after determining that it is safe to execute the trajectory defined by the third signal.

8. A non-transitory computer-readable storage medium comprising computer-readable instructions executable by a processor to perform or control performance of the method of claim 1.

9. A method to control an autonomous vehicle comprising:
receiving autonomous input for an autonomous vehicle, the autonomous input comprising one or both of a planned trajectory or a planned behavior;
receiving teleoperator input comprising one or both of a trajectory adjustment or a behavior authorization; and
outputting a trajectory signal that depends on both the autonomous input and the teleoperator input, the trajectory signal comprising one or both of an updated planned trajectory or an authorized planned behavior.

10. The method of claim 9, further comprising:
determining whether it is safe for the autonomous vehicle to implement one or both of the updated planned trajectory or the authorized planned behavior; and
executing at the autonomous vehicle one or both of the updated planned trajectory or the authorized planned behavior only after determining that it is safe to do so.

11. The method of claim 9, wherein the autonomous input comprises the planned behavior and the planned behavior is automatically triggered based on contextual information.

12. The method of claim 11, wherein the contextual information includes at least one of a geographic location, a lane location, a hotspot type, a time of day, a season, weather conditions, or a current teleoperator for the autonomous vehicle.

13. The method of claim 9, wherein the autonomous input comprises the planned behavior, the planned behavior is obtained from a library of predefined behaviors, and the predefined behaviors are populated in the library over time based on prior authorizations of the predefined behaviors by a plurality of teleoperators.

14. The method of claim 9, wherein the planned behavior includes at least one of throttle control, brake control, steering control to maintain lane-keeping, distance control to maintain distance between the autonomous vehicle and other vehicles, overtaking other vehicles on the left, collision avoidance, or merging.

15. The method of claim 9, further comprising:
determining trajectory components to implement the updated planned trajectory or the authorized planned behavior; and
executing the updated planned trajectory or the authorized planned behavior, including executing the trajectory components at a drive by wire system of the autonomous vehicle.

16. A non-transitory computer-readable storage medium comprising computer-readable instructions executable by a processor to perform or control performance of operations comprising:
receiving autonomous input for an autonomous vehicle, the autonomous input comprising one or both of a planned trajectory or a planned behavior;
receiving teleoperator input comprising one or both of a trajectory adjustment or a behavior authorization; and
outputting a trajectory signal that depends on both the autonomous input and the teleoperator input, the trajectory signal comprising one or both of an updated planned trajectory or an authorized planned behavior.

17. The non-transitory computer-readable storage medium of claim 16, the operations further comprising:
determining whether it is safe for the autonomous vehicle to implement one or both of the updated planned trajectory or the authorized planned behavior; and
executing at the autonomous vehicle one or both of the updated planned trajectory or the authorized planned behavior only after determining that it is safe to do so.

18. The non-transitory computer-readable storage medium of claim 16, wherein the autonomous input comprises the planned behavior and the planned behavior is automatically triggered based on contextual information.

19. The non-transitory computer-readable storage medium of claim 18, wherein the contextual information includes at least one of a geographic location, a lane location, a hotspot type, a time of day, a season, weather conditions, or a current teleoperator for the autonomous vehicle.

20. The non-transitory computer-readable storage medium of claim 16, wherein the autonomous input comprises the planned behavior, the planned behavior is obtained from a library of predefined behaviors, and the predefined behaviors are populated in the library over time based on prior authorizations of the predefined behaviors by a plurality of teleoperators.
